(19) United States
(12) Patent Application Publication
(10) Pub. No.: US 2018/0247575 A1
(43) Pub. Date: Aug. 30, 2018

(54) Street Furniture System and Integrated Billboard

(71) Applicant: Gerry Panzu Konde, Boston, MA (US)

(72) Inventor: Gerry Panzu Konde, Boston, MA (US)

(21) Appl. No.: 15/913,860

(22) Filed: Mar. 6, 2018

Related U.S. Application Data
(60) Provisional application No. 62/443,463, filed on Jan. 6, 2017.

(51) Int. Cl. G09F 27/00; G06Q 30/02; H02J 7/00

(52) U.S. Cl. CPC G09F 27/007; G09F 27/005; G09F 9/35; H02J 7/0027; G06Q 30/0246

(57) ABSTRACT

A street furniture system and interconnected digital billboard consists of a plurality of connectivity stations, a centralized display unit, and a power source. The plurality of connectivity stations and the centralized display unit are powered through the power source. A central processing unit (CPU) of each of the plurality of connectivity stations and a CPU of the centralized display unit communicably couples the plurality of connectivity stations and the centralized display unit. Therefore, by controlling a plurality of computing devices from each of the plurality of connectivity stations, the content displayed on a front display screen of the centralized display unit can be controlled. A global positioning system (GPS) module, a plurality of cameras, and a plurality of motion-detecting sensors of the centralized display unit are used to determine and display the most appropriate content on the front display screen.

The current application claims a priority to the U.S. Provisional Patent application Ser. No. 62/443,463 filed on Jan. 6, 2017.

### FIELD OF THE INVENTION

The present invention relates generally to a billboard street furniture system wherein a powered billboard can gather metrics of the local area, communicate with the street furniture directly providing user interaction with out-of-home advertising through touchscreen operation.

### BACKGROUND OF THE INVENTION

The power and benefit of out of home advertising is growing in recent years to advertisers as the versatility and emergence of more robust ad blocking software makes itself available to the public. Out of home advertising provides a passive reception to its intended audience as conventional billboards have provided for the last century where a populace will catch a billboard at a glance to potentially implant the desire for pedestrian/automotive traffic to purchase the advertiser's products. The difficulty with passive viewership at the pedestrian level of operation however is it does not guarantee a necessarily high degree of return regarding populace to product purchase as it relies on the viewer actively seeking out a retail establishment, or being at heart, able to captivate the advertiser's intended audience in a potentially short time of operation, or generally just being an eyesore that the pedestrian traffic has no control over and may elect to gloss over. At the advertiser level the concerns magnify where the advertising space often must solely rely on the quantity of products purchased when rating its advertising campaign. Further to this, advertisers ultimately find themselves unable to react in a timely manner that would otherwise permit them to cater to the consumer demand handily. The apparatus discussed herewith would seek to provide a desired means to measure the metrics of the product reception relative to pedestrian traffic. Being able to measure not only the positive reception of the advertising, but the negative reception in real time as well, providing perhaps the fastest feedback advertisers could hope for. The benefits of the apparatus do not solely belong to the advertisers however as the street furniture would further provide measures to captivate pedestrian traffic through services such as user interaction by touchscreen, providing a Wi-Fi hub that provides free internet to the local area and able to alter the central billboard's current content. The apparatus may further provide a place of respite that in one form of operation provides: cooled seats, hand warmers, a distiller/water depository, and USB charging ports to keep pedestrian traffic interested and making use of the billboard.

### BRIEF DESCRIPTION OF THE DRAWINGS

FIG. 1A is an illustration of the plurality of connectivity stations and the centralized display unit.

FIG. 1B is a block diagram illustrating the components of the plurality of connectivity stations and the centralized display unit.

FIG. 2 is an illustration of an arbitrary connectivity station from the plurality of connectivity stations in a first embodiment of the present invention.

FIG. 3 is an illustration of an arbitrary connectivity station from the plurality of connectivity stations in a second embodiment of the present invention.

FIG. 4 is a perspective view of the centralized display unit in one embodiment of the present invention.

FIG. 5 is a front view of the centralized display unit in another embodiment of the present invention.

FIG. 6 is a top view illustrating the positioning of the plurality of connectivity stations and the centralized display unit, wherein the housing of the centralized display unit is rotatable.

### DETAIL DESCRIPTIONS OF THE INVENTION

All illustrations of the drawings are for the purpose of describing selected versions of the present invention and are not intended to limit the scope of the present invention.

The present invention is an assembly consisting of street furniture and an interconnected display that enhances outdoor user experience in public areas. By utilizing the present invention, the user gets personalized viewing material regardless of the location. The present invention is intended to be used in public areas that can be, but is not limited to, airports, train stations, and malls.

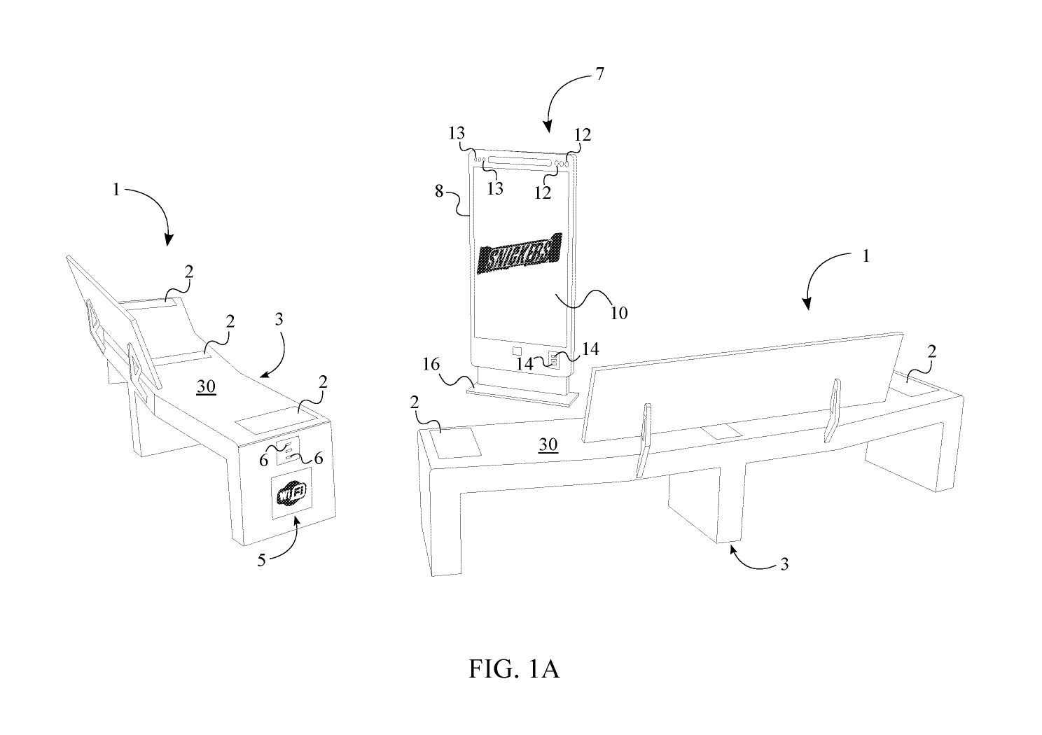

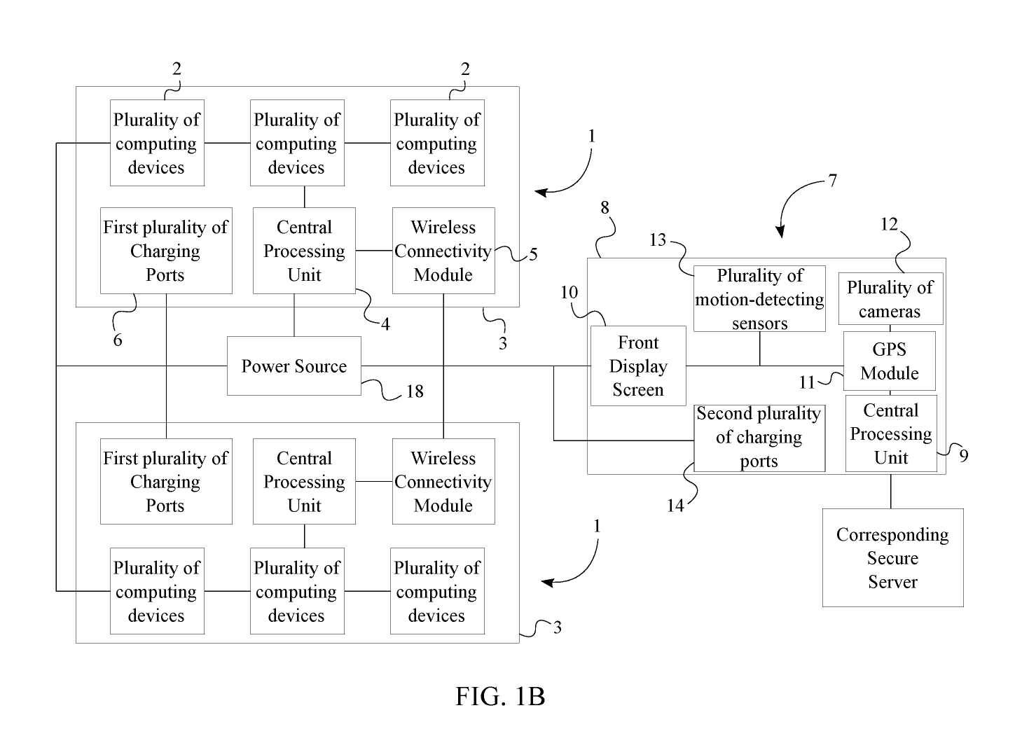

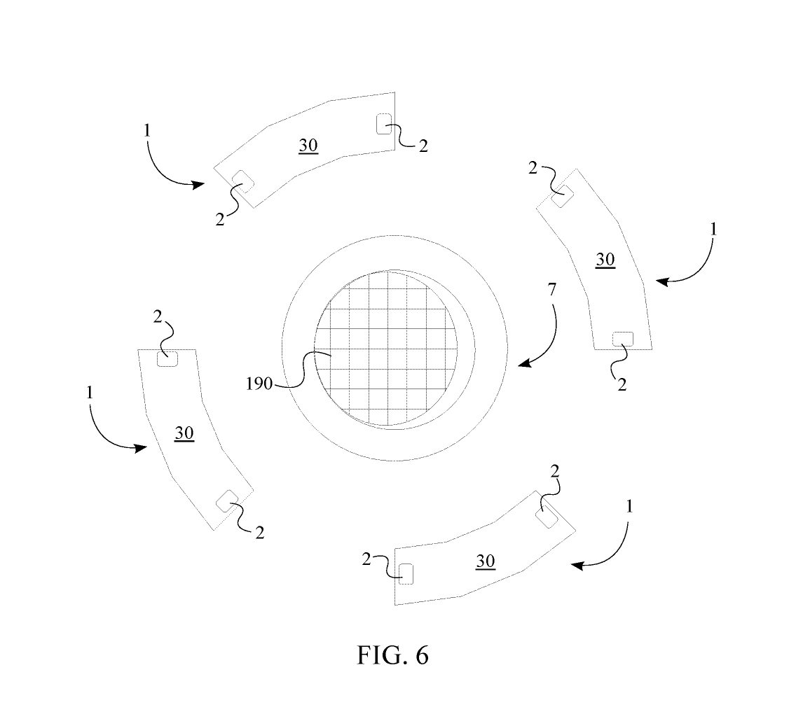

As shown in FIG. 1A, FIG. 1B, and FIG. 6, to achieve the intended functionalities, the present invention comprises a plurality of connectivity stations 1, a centralized display unit 7, and a power source 18. Preferably, the plurality of connectivity stations 1 will be designed as benches and be positioned radially around the centralized display unit 7. Thus, when using the present invention, the users can utilize the plurality of connectivity stations 1 and the centralized display unit 7 simultaneously. The electrical power required for functioning is provided through the power source 18. To do so, the plurality of connectivity stations 1 and the centralized display unit 7 are electrically connected to the power source 18 that can vary in different embodiments of the present invention.

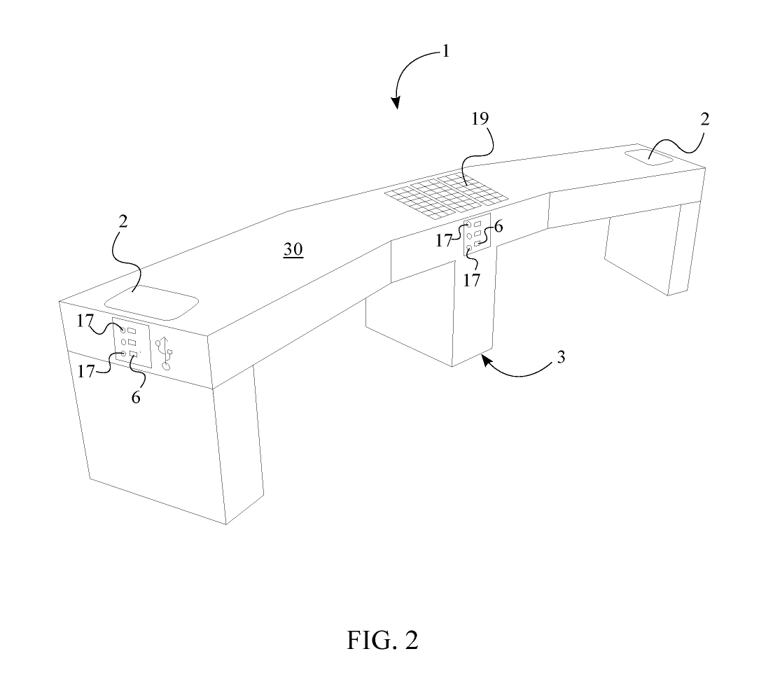

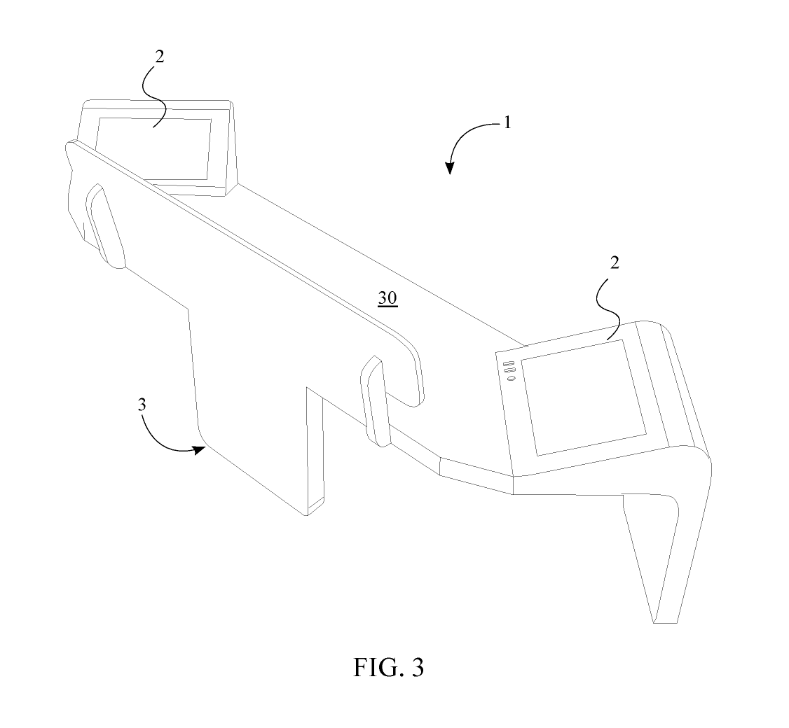

As seen in FIG. 1B, FIG. 2, and FIG. 3, the plurality of connectivity stations 1 and the centralized display unit 7 are designed to enhance public engagement. To do so, each of the plurality of connectivity stations 1 comprises a structural body 3, a wireless connectivity module 5, a central processing unit (CPU) 4, and a plurality of computing devices 2. The structural body 3 determines the overall size and shape of each of the plurality of connectivity stations 1. As mentioned previously, in the preferred embodiment, the plurality of connectivity stations 1 is designed as benches. However, in other embodiments of the present invention, the plurality of connectivity stations 1 can be designed differently and vary in size and shape. The wireless connectivity module 5, mounted onto the structural body 3, is used to establish and provide a wireless local area network. Thus, the users utilizing the plurality of connectivity stations 1 and other users in the vicinity of the present invention are provided with wireless network connectivity. The CPU 4 of each of the plurality of connectivity stations 1 manages the incoming data flow and the outgoing data flow for each of the plurality of connectivity stations 1. In general, the CPU 4 of each of the plurality of connectivity stations 1 functions as the contact point for interactions between the centralized display unit 7 and each of the plurality of connectivity stations 1. The plurality of computing devices 2, which can vary in size, type, and shape in different embodiments, functions as the user interface when utilizing the present invention. As an example, each of the plurality of computing devices 2 can be used individually to control the centralized display unit 7. In another instance, each of the plurality of computing devices 2 can be solely used for web browsing via the wireless local area network established by the wireless connectivity module 5. Similar to the wireless connectivity module 5, the plurality of computing devices 2 is also mounted onto the structural body 3. However, in another embodiment of the present invention, the plurality of computing devices 2 can be removably attached to the structural body 3. To interconnect the plurality of computing devices 2, the wireless connectivity module 5, and the CPU 4 of each of the plurality of connectivity stations 1, the plurality of computing devices 2 and the wireless connectivity module 5 are communicably coupled with the CPU 4 of each of the plurality of connectivity stations 1.

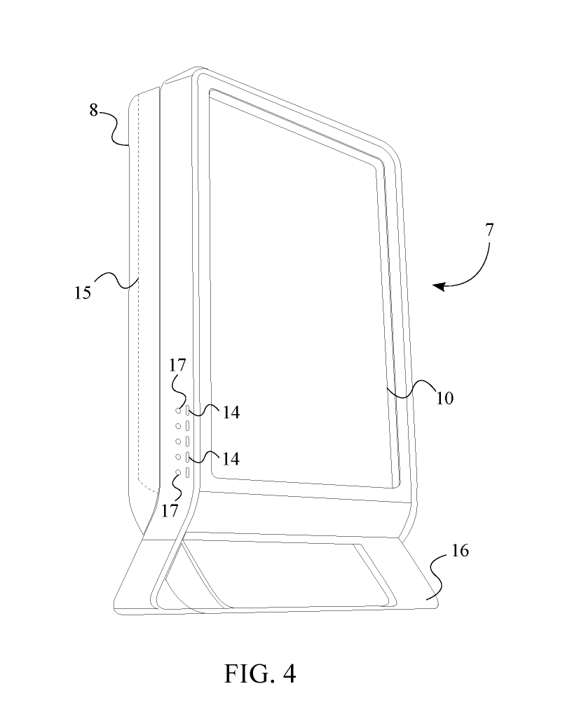

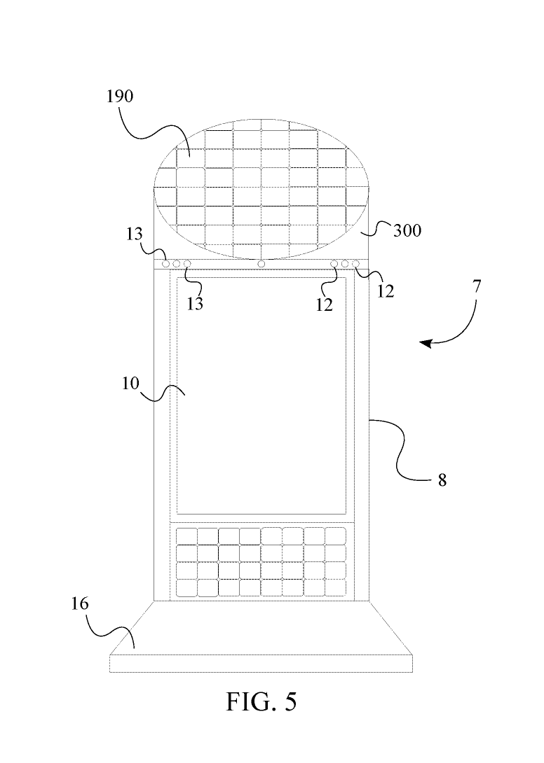

As seen FIG. 1B, FIG. 4 and FIG. 5, the centralized display unit 7, designed to enhance public engagement, can vary in different embodiments. In the preferred embodiment of the present invention, the centralized display unit 7 comprises a housing 8, a CPU 9, and a front display screen 10. However, in another embodiment of the present invention, the centralized display unit 7 can be a wall-mounted display unit. The housing 8 provides the structural strength to the centralized display unit 7. The size and shape of the housing 8 and the material of the housing 8 can vary in different embodiments of the present invention. The front display screen 10 is used to display the viewing material selected by the user of the present invention. The size and shape of the front display screen 10, which is externally mounted onto the housing 8, can vary from one embodiment to another. Similar to the CPU 4 of each of the plurality of connectivity stations 1, the CPU 9 of the centralized display unit 7, positioned within the housing 8, manages the incoming data flow and the outgoing data flow for the centralized display unit 7. More specifically, the CPU 9 of the centralized display unit 7 functions as the contact point for interactions between the plurality of connectivity stations 1 and the centralized display unit 7. For the front display screen 10 to display content according to the user instructions received at the CPU 9 of the centralized display unit 7, the front display screen 10 is electronically connected to the CPU 9 of the centralized display unit 7.

As discussed before, the plurality of connectivity stations 1 and the centralized display unit 7 are interconnected. Moreover, the incoming data flow and the outgoing data flow are managed through the CPU 4 of the plurality of connectivity stations 1 and the CPU 9 the centralized display unit 7. Therefore, to complete the connection between the plurality of connectivity stations 1 and the centralized display unit 7, the CPU 4 of each of the plurality of connectivity stations 1 is electronically connected to the CPU 4 of the centralized display unit 7. For the user to utilize an arbitrary connectivity station from the plurality of connectivity stations 1 and simultaneously view the centralized display unit 7, the front display screen 10 is oriented towards the plurality of connectivity stations 1.

The present invention is intended to be used in areas such as malls, airports, and train stations. As seen in FIG. 1B, to enhance and customize the interactions with users based upon the geographic location, the centralized display unit 7 further comprises a global positioning system (GPS) module 11. The GPS module 11, which is integrated into the housing 8, is electronically connected to the CPU 9 of the centralized display unit 7. Based upon the location coordinates received from the GPS module 11, the CPU 9 of the centralized display unit 7 retrieves a plurality of location related information from a corresponding secure server that is electronically connected to the CPU 9 of the centralized display unit 7. As a result, the front display screen 10 will display the plurality of location related information.

As illustrated in FIG. 1A and FIG. 5, to display the most relevant information and boost the quality of user experience, the centralized display unit 7 further comprises a plurality of cameras 12. More specifically, the plurality of cameras 12 is used to clearly determine the potential users in the vicinity of the present invention and display the most relevant information. As an example, if a group of children is in the vicinity of the present invention, the front display screen 10 proceeds to display content appropriate to the children. To achieve the aforementioned functionalities, the plurality of cameras 12 is externally mounted onto the housing 8 and oriented towards the plurality of connectivity stations 1. Moreover, the plurality of cameras 12 is positioned adjacent the front display screen 10 so that the users intending to view the front display screen 10 can be clearly seen through the plurality of cameras 12. When an input is received from the plurality of cameras 12, the CPU 9 of the centralized display unit 7 proceeds to retrieve the relevant information from the corresponding secure server. To do so, the plurality of cameras 12 is electronically connected to the CPU 9 of the centralized display unit 7.

In addition to the capability of categorizing the potential users, the present invention can also identify the presence of potential users in the vicinity. To do so, as shown in FIG. 1A and FIG. 5, the centralized display unit 7 further comprises a plurality of motion-detecting sensors 13 that is externally mounted onto the housing 8. Moreover, the plurality of motion-detecting sensors 13 is positioned adjacent the front display screen 10 so that the potential users that can view the front display screen 10 are identified. When detected, the CPU 9 of the centralized display unit 7 proceeds to retrieve the plurality of location related information from the corresponding secure server. To do so, the plurality of motion-detecting sensors 13 is electronically connected to the CPU 9 of the centralized display unit 7.

Finding a charging port for a mobile computing device in a public area can be very stressful and time consuming. As shown in FIG. 2, to address the issue, each of the plurality of connectivity stations 1 comprises a first plurality of charging ports 6 that is integrated into the structural body 3. To fulfill the charging functionalities, the first plurality of charging ports 6 is electronically connected to the power source 18. The present invention, further comprises a plurality of indicator lights 17 that is positioned adjacent the first plurality of charging ports 6. The plurality of indicator lights 17 helps the user locate the first plurality of charging ports 6 in low-light conditions. To illuminate as intended, the plurality of indicator lights 17 is electronically connected to the power source 18.

As illustrated in FIG. 4, in addition to the first plurality of charging ports 6, the centralized display unit 7 further comprises a second plurality of charging ports 14 that is integrated into the housing 8. To fulfill the charging functionalities, the second plurality of charging ports 14 is electronically connected to the power source 18. Similar to the plurality of indicator lights 17 on each of the plurality of connectivity stations 1, the plurality of indicator lights 17 is also positioned adjacent the second plurality of charging ports 14 to aid in low-light conditions. To illuminate as intended, the plurality of indicator lights 17 is electronically connected to the power source 18.

As further illustrated in FIG. 4, in a different embodiment of the present invention, the centralized display unit 7 further comprises a rear display screen 15. The rear display screen 15 is especially beneficial when a significant number of users are utilizing the front display screen 10 that is oriented towards the plurality of connectivity stations 1. In another instance, if the plurality of location related information is significant, the rear display screen 15 is beneficial to showcase the additional information. When available, the rear display screen 15 will be mounted onto the housing 8 similar to the front display screen 10 and be positioned opposite to the front display screen 10. The positioning of the rear display screen 15 allows the present invention to display viewing content to users spread across a larger area. Similar to the front display screen 10, the rear display screen 15 is also electronically connected to the CPU 9 of the centralized display unit 7. Thus, the viewing content displayed on the rear display screen 15 is managed through the CPU 9 of the centralized display unit 7.

As mentioned before, the power source 18 can vary in different embodiments of the present invention. For energy conservation purposes, in another embodiment of the present invention, the power source 18 further comprises a first solar array 19. As shown in FIG. 2, the first solar array 19 is externally mounted onto a top surface 30 of the structural body 3. To power the plurality of connectivity stations 1, the first solar array 19 is electrically connected to the plurality of connectivity stations 1.

To power the centralized display unit, the power source 18 comprises a second solar array 190. As shown in FIG. 5, to fulfill the intended functionalities, the second solar array 190 is externally mounted onto a top surface 300 of the housing 8 and electrically connected to the centralized display unit 7. The electrical connection between the power source 18, the plurality of connectivity stations 1, and the centralized display unit 7 ensures that the electricity generated from the first solar array 19 and the second solar array 190 is transferred onto the plurality of connectivity stations 1 and the centralized display unit 7. In another embodiment of the present invention, an additional solar array can be positioned around each of the plurality of connectivity stations 1 and the centralized display unit 7.

Preferably, the plurality of connectivity stations 1 is designed as benches. For each of the plurality of connectivity stations 1 to be used for seating purposes a top surface 30 of each of the plurality of connectivity stations 1 is planar. The surface area of the top surface 30 can vary from one embodiment to another. In the preferred embodiment, the top surface 30 is designed and sized to seat two adult individuals. However, in other embodiments, the top surface 30 can vary in surface area so that a different number of individuals can be seated. In another embodiment of the present invention, a top surface 30 of each of the plurality of connectivity stations 1 is concave. Thus, rain water is directed away from the top surface.

As discussed, the size and shape of the centralized display unit 7 can vary in different embodiments as long as the functionality of the present invention remains the same. In another embodiment of the present invention, the centralized display unit 7 further comprises a base section 16. The housing 8 of the centralized display unit 7 is mounted onto the base section 16 such that the housing 8 is positioned perpendicular to the base section 16. In addition to providing structural strength, the base section 16 also allows the housing 8 to be rotatably mounted in another embodiment so that the front display screen 10 can be rotated in a 360-degree angle.

When considering the method of using the present invention with the aforementioned components, the following process flow is generally followed. Initially, the plurality of connectivity stations 1 and the centralized display unit 7 are provided in an area which can be, but is not limited to, a mall or an airport. The geolocation of the present invention is identified through the GPS module 11 of the centralized display unit 7. When identified, the present invention proceeds to retrieve the plurality of location related information from the corresponding secure server connected to the CPU 9 of the centralized display unit 7. When retrieved, the plurality of location related information is transferred onto the CPU 9 of the centralized display unit 7 and the CPU 4 of the plurality of connectivity stations 1. Next, the present invention displays the plurality of location related information on the front display screen 10 and on the plurality of computing devices 2. The plurality of location related information can be, but is not limited to, local weather, flight details, and retail offers. As an example, if the present invention is located in an airport, the front display screen 10 will display flight details. In another example, if the present invention is located in a mall, the front display screen 10 will display offers from retail stores in the mall.

As introduced earlier, the centralized display unit 7 comprises a plurality of cameras 12 and a plurality of motion-detecting sensors 13 that are used to identify the potential users of the present invention. In doing so, the present invention monitors the plurality of cameras 12 and the plurality of motion-detecting sensors 13. Based upon the input received from the plurality of cameras 12 and the plurality of motion-detecting sensors 13, the present invention retrieves the plurality of location related information accordingly. As an example, if a group of airline passengers is utilizing the present invention, the airline passengers are identified via the plurality of cameras 12, and flight details and other comparable information is displayed as the plurality of location related information.

When a first user is seated at an arbitrary connectivity station of the plurality of connectivity stations 1, the present invention prompts the first user to dynamically control the plurality of computing devices 2 and thereby control the front display screen 10. By doing so, the first user can proceed to display and control the content on the front display screen 10. If a second user is also utilizing the arbitrary connectivity station, the preferred content of the second user will be displayed on the front display screen 10 after the preferred content of the first user is displayed. In another embodiment, when the plurality of computing devices 2 of each the plurality of connectivity stations 1 is occupied, the first user or the second user, can establish a user account and utilize the present invention through a mobile application on a mobile computing device. When the user account is utilized with the present invention, the content displayed on the at least one screen will be based upon the browsing history and preferences of the user. As an example, if the user previously browsed for nearby restaurants, the present invention proceeds to display offers from nearby restaurants. Based upon the displayed content, the user can proceed to a preferred restaurant or get food delivered by sharing the location through the GPS module 11.

Although the invention has been explained in relation to its preferred embodiment, it is to be understood that many other possible modifications and variations can be made without departing from the spirit and scope of the invention as hereinafter claimed.

What is claimed is:

1. A street furniture system and interconnected digital billboard comprises:
a plurality of connectivity stations;
a centralized display unit;
a power source;
each of the plurality of connectivity stations comprises a plurality of computing devices, a structural body, a central processing unit (CPU), and a wireless connectivity module;
the centralized display unit comprises a housing, a CPU, and a front display screen, wherein the CPU is electronically connected to a corresponding secure server;
the plurality of connectivity stations and the centralized display unit being electrically connected to the power source;
the plurality of computing devices and the wireless connectivity module being mounted onto the structural body;
the plurality of computing devices and the wireless connectivity module being communicably coupled with the CPU for each of the plurality of connectivity stations;
the front display screen being electronically connected to the CPU of the centralized display unit;
the front display screen being externally mounted onto the housing;
the CPU of the centralized display unit being positioned within the housing;
the CPU of each of the plurality of connectivity stations being electronically connected to the CPU of the centralized display unit;
the plurality of connectivity stations being positioned radially around the centralized display unit; and
the front display screen being oriented towards the plurality of connectivity stations.

2. The street furniture system and interconnected digital billboard as claimed in claim 1 further comprises:
the centralized display unit further comprises a global positioning system (GPS) module;
the GPS module being electronically connected to the CPU of the centralized display unit; and
the GPS module being integrated into the housing.

3. The street furniture system and interconnected digital billboard as claimed in claim 1 further comprises:
the centralized display unit further comprises a plurality of cameras;
the plurality of cameras being externally mounted onto the housing and oriented towards the plurality of connectivity stations;
the plurality of cameras being positioned adjacent the at least one screen; and
the plurality of cameras being electronically connected to the CPU of the centralized display unit.

4. The street furniture system and interconnected digital billboard as claimed in claim 1 further comprises:
the centralized display unit further comprises a plurality of motion-detecting sensors;
the plurality of motion-detecting sensors being externally mounted onto the housing;
the plurality of motion-detecting sensors being positioned adjacent the at least one screen; and
the plurality of motion-detecting sensors being electronically connected to the CPU of the centralized display unit.

5. The street furniture system and interconnected digital billboard as claimed in claim 1 further comprises:
each of the plurality of connectivity stations further comprises a first plurality of charging ports;
the first plurality of charging ports being integrated into the structural body; and
the first plurality of charging ports being electronically connected to the power source.

6. The street furniture system and interconnected digital billboard as claimed in claim 5 further comprises:
a plurality of indicator lights;
the plurality of indicator lights being positioned adjacent the first plurality of charging ports; and
the plurality of indicator lights being electronically connected to the power source.

7. The street furniture system and interconnected digital billboard as claimed in claim 1 further comprises:
the centralized display unit further comprises a second plurality of charging ports;
the second plurality of charging ports being integrated into the housing; and
the second plurality of charging ports being electronically connected to the power source.

8. The street furniture system and interconnected digital billboard as claimed in claim 7 further comprises:
a plurality of indicator lights;
the plurality of indicator lights being positioned adjacent the second plurality of charging ports; and
the plurality of indicator lights being electronically connected to the power source.

9. The street furniture system and interconnected digital billboard as claimed in claim 1 further comprises:
the centralized display unit further comprises a rear display screen;
the rear display screen being externally mounted onto the housing;
the rear display screen being positioned opposite the front display screen and across the housing; and
the rear display screen being electronically connected to the CPU of the centralized display unit.

10. The street furniture system and interconnected digital billboard as claimed in claim 1 further comprises:
the power source comprises a first solar array;
the first solar array being externally mounted onto a top surface of the structural body; and
the first solar array being electrically connected to the plurality of connectivity stations.

11. The street furniture system and interconnected digital billboard as claimed in claim 1 further comprises:
the power source comprises a second solar array;
the second solar array being externally mounted onto a top surface of the housing; and
the second solar array being electrically connected to the centralized display unit.

12. The street furniture system and interconnected digital billboard as claimed in claim 1, wherein a top surface of each of the plurality of connectivity stations is planar.

13. The street furniture system and interconnected digital billboard as claimed in claim 1, wherein a top surface of each of the plurality of connectivity stations is concave.

14. The street furniture system and interconnected digital billboard as claimed in claim 1 further comprises:
the centralized display unit further comprises a base section;
the housing being mounted atop the base section; and
the housing being positioned perpendicular to the base section.

15. The street furniture system and interconnected digital billboard as claimed in claim 14, wherein the housing is rotatably mounted onto the base section.
